(19) United States
(12) Patent Application Publication
(10) Pub. No.: US 2026/0351856 A1
(43) Pub. Date: Nov. 5, 2026

(54) DUAL SPEAKER-SLOT ANTENNAS

(71) Applicant: DELL PRODUCTS L.P., Round Rock, TX (US)

(72) Inventors: Sumana Pallampati, Austin, TX (US); Changsoo Kim, Cedar Park, TX (US); Ching Wei Chang, Round Rock, TX (US)

(21) Appl. No.: 19/198,378

(22) Filed: May 5, 2025

(51) Int. Cl. H01Q 13/10; H01Q 1/22

(52) U.S. Cl. CPC H01Q 13/10; H01Q 1/2291

(57) ABSTRACT

A dual-slot antenna system within a metal chassis of an information handling system includes a pair of spaced-apart speaker slots formed in the metal chassis. The dual-slot antenna system includes a signal feed mechanism. The signal feed mechanism is formed on a speaker box positioned within the metal chassis adjacent to the pair of spaced-apart speaker slots. The speaker box houses one or more speaker transducers. The signal feed mechanism is configured to feed radio frequency (RF) energy to the pair of spaced-apart speaker slots. The RF energy fed by the signal feed mechanism to the pair of spaced-apart speaker slots is capable of exciting the pair of spaced-apart speaker slots to operate as dual slot antennas.

### FIELD OF THE DISCLOSURE

The present disclosure generally relates to information handling systems, and more particularly relates to antennas and related apparatuses for endowing information handling systems with wireless communication capabilities.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

A dual-slot antenna system within a metal chassis of an information handling system includes a pair of spaced-apart speaker slots formed in the metal chassis. The dual-slot antenna system includes a signal feed mechanism. The signal feed mechanism is formed on a speaker box positioned within the metal chassis adjacent to the pair of spaced-apart speaker slots. The speaker box houses one or more speaker transducers. The signal feed mechanism is configured to feed radio frequency (RF) energy to the pair of spaced-apart speaker slots. The RF energy fed by the signal feed mechanism to the pair of spaced-apart speaker slots is capable of exciting the pair of spaced-apart speaker slots to operate as dual slot antennas.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIGS. 1A and 1B are diagrams an information handling system chassis according to at least one embodiment of the present disclosure;

FIG. 2 is a partially exploded view of the base of an information handling system chassis containing a dual-slot antenna system according to at least one embodiment of the present disclosure;

FIGS. 3A-3C illustrate a dual-slot antenna system configured to excite a pair of spaced-apart speaker slots via a coupled feed according to at least one embodiment of the present disclosure;

FIGS. 4A-4C illustrate a dual-slot antenna system configured to excite a pair of spaced-apart speaker slots via a direct feed according to at least one embodiment of the present disclosure;

FIG. 5 is a flow diagram of a method for exciting a pair of spaced-apart speaker slots formed in an information handling system metal chassis to operate as dual slot antennas according to at least one embodiment of the present disclosure; and

FIG. 6 is a block diagram of a general information handling system according to at least one embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

In addition, the information handling system may also include communications circuitry such as a transceiver and one or more antennas for wirelessly receiving and transmitting data. Endowing information handling systems such as laptops and tablets with wireless communication capabilities, however, may present several challenges given the trend towards housing such information handling systems in ever-thinner, more streamlined metal chassis. With respect to a laptop, for example, an antenna cannot be placed in the conventional location above the laptop's display if the laptop cover is made of metal. Placing the antenna in the laptop base limits the space available for a thermal solution, motherboard area, and wireless wide-area network (WWAN) antennas (for devices that support WWAN communications). Moreover, placement of the antenna within a single antenna vent formed in the laptop base may not adequately cover the full frequency range of WiFi 7.

In accordance with embodiments of the present disclosure, a pair of spaced-apart speaker slots formed in a metal information handling system chassis are configured to serve the dual purpose of permitting sound generated by a speaker system to emanate outward from the chassis and simultaneously to operate as slot antennas. Thus, rather than creating a separate antenna vent, the pair of spaced-apart speaker slots are utilized. Rather than placing an antenna with a vent formed in the chassis, the speaker slots themselves are energized to operate as dual slot antennas. As slot antennas, the pair of spaced-apart speaker slots are driven by a radiofrequency (RF) signal fed to the speaker slots from a signal feed mechanism collocated with a speaker box within the information handling system chassis, thus more efficiently utilizing limited space within the chassis. To further conserve space, the signal feed mechanism that energizes the speaker slots may be a monopole antenna (e.g., 5 GHz monopole antenna) imprinted on the speaker box using laser direct structuring (LDS), the LDS process creating an LDS antenna formed of conductive traces for couple feeding RF energy to the speaker slots. In other embodiments, LDS traces may be imprinted for soldering feed and ground coaxial cables that directly feed RF energy to the speaker slots via a pogo pin that extends to and contacts with the chassis adjacent the speaker slots formed within the chassis. Although the embodiments of the present disclosure are described primarily in the context of a portable chassis (such as a laptop or tablet computer), the dual-slot antenna system described may, in different embodiments, be implemented in other types of metal chassis for housing other types of information handling systems.

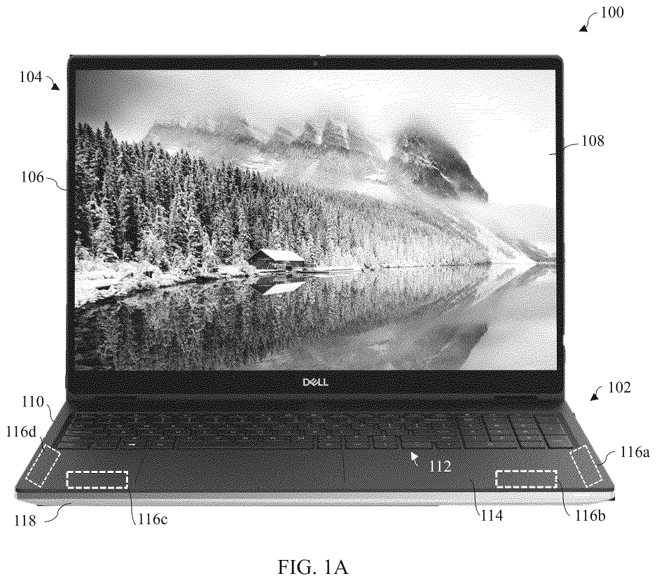

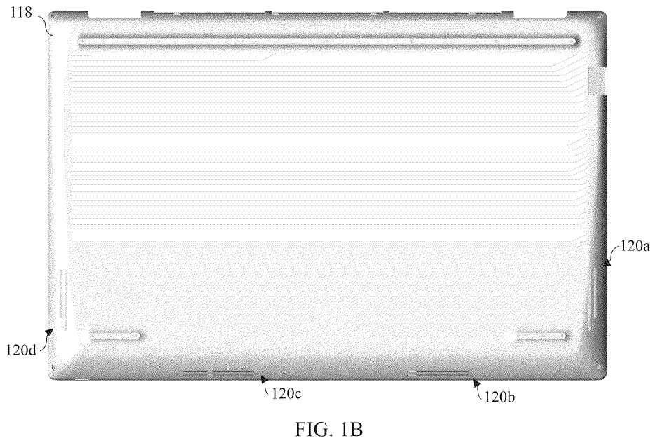

FIG. 1A is a perspective view of a portable, or laptop, chassis 100 of an information handling system according to an embodiment of the present disclosure. Portable chassis 100 includes base 102 and lid 104. Lid 104 pivotally connects to base 104 and includes a metal A-cover (not in view) that forms the back of B-cover 106, in which display screen 108 is embedded. C-cover 110 of base 102 illustratively includes keyboard 112, palm rest 114. An antenna may be positioned within base 102 below C-cover locations 116a, 116b, 116c, or 116d Depending on the location of the antenna within base 102, an antenna window made of an RF-transparent material may be formed in C-cover 110 if the C-cover is otherwise made of metal. FIG. 1B is a perspective bottom view of metal D-case 118 of base 102. D-case 118 covers the bottom portion of base 110, which houses the working components of the information handling system. To provide structural integrity and durability, as well as aesthetic appeal, D-case 118 is formed of a metal such as aluminum or aluminum alloy or magnesium or magnesium alloy. Portable chassis 100 includes a pair of spaced-apart speaker slots. The spaced-apart speaker slots are formed by apertures or openings that extend through a wall portion of D-case 118 at position 120a, 120b, 120c, or 120d depending on the location of a speaker system within chassis 100.

FIG. 2 is a partially exploded view of base 102 illustratively housing dual-slot antenna system 200. Dual-slot antenna system 200 is configured to support wireless communications performed with the information handling system 100. Illustratively, dual-slot antenna system 200 includes dual spaced-apart speaker slots 202a and 202b, signal feed mechanism 204, and conductive gaskets 206 and 208. Dual-slot antenna system 200 is positioned within D-case 118 formed of metallic material. At least a portion of C-cover 110 may also be formed from a metallic material. Conductive gasket 206 is configured to ground signal feed mechanism 204 to a metallic portion of C-cover 110, and conductive gasket 208 is configured to ground the signal feed mechanism to D-case 118. Antenna window 210 may be formed in a region of C-cover 110 extending over dual spaced-apart speaker slots 202a and 202b, the antenna window formed from a dielectric material such as plastic to provide RF transparency.

In certain embodiments, signal feed mechanism 204 is formed on a speaker box that acts as a speaker cavity of base 102, the speaker box containing one or more speaker transducers. Signal feed mechanism 204 may be formed from conductive traces imprinted on the speaker box using the process of laser direct structuring (LDS). Operatively, signal feed mechanism 204 is configured to feed RF energy 212 to the pair of spaced-apart speaker slots 202a and 202b. Signal feed mechanism 204 may be excited by a transmitter or transceiver housed within base 102. RF energy 212 fed to spaced-apart speaker slots 202a and 202b by signal feed mechanism 204 is capable of exciting the pair of spaced-apart speaker slots to operate as dual slot antennas. In certain embodiments, RF energy 212 is fed to spaced-apart speaker slots 202a and 202b by signal feed mechanism 204 via a direct feed. In other embodiments, RF energy 212 is fed to spaced-apart speaker slots 202a and 202b by signal feed mechanism 204 via a coupled feed.

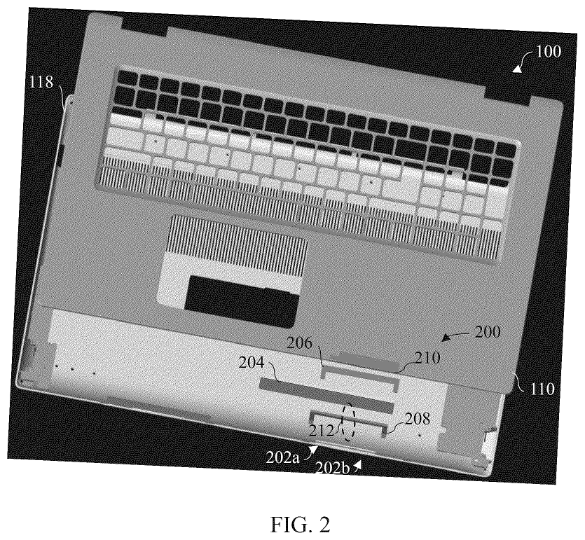

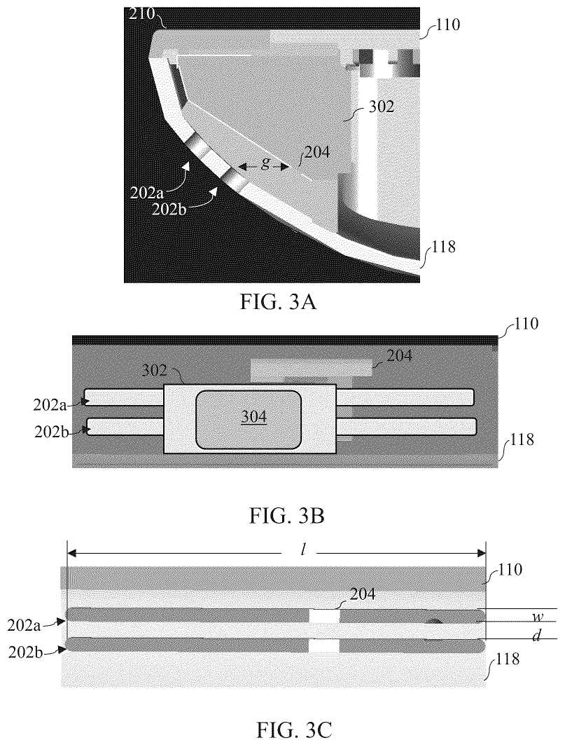

FIGS. 3A-3C illustrate an embodiment in which dual-slot antenna system 200 is configured to excite the pair of spaced-apart speaker slots 202a and 202b via a coupled feed according to certain embodiments of this disclosure. FIG. 3A is a cross-sectional view of an interior portion of D-case 118 of chassis 100 with signal feed mechanism 204 formed on speaker box 302. 3B is a cross-sectional forward view of the interior portion of D-case showing speaker box 302, within which is housed speaker transducer 304, and with spaced-apart speaker slots 202a and 202b behind the speaker box. FIG. 3C is a forward view of spaced-apart speaker slots 202 a and 202 b, looking into D-case 118. Signal feed mechanism 204 is configured as a 5 GHz coupling feed monopole formed on speaker box 302, which houses speaker transducer 304 within D-case 118. As a coupling feed monopole, signal feed mechanism 204 is a conductor capable of acting as a source of RF energy for exciting spaced-apart speaker slots 202a and 202b to act as dual slot antennas. Formed as a 5 GHz coupling feed monopole, signal feed mechanism 204 is configured to generate an electromagnetic field that induces an electric current in the edges of spaced-apart speaker slots 202a and 202b that excites the speaker slots to operate as dual slot antennas. Signal feed mechanism 204 generates electromagnetic waves that traverse gap g between the signal feed mechanism (coupling feed monopole) and spaced-apart speaker slots 202a and 202b.

The coupling between the monopole and the spaced-apart speaker slots depends on their relative positioning, the frequency of operation, and the design of the slot. In certain embodiments, the lengthwise extent l of each of the pair of spaced-apart speaker slots 202a and 202b is approximately 50 millimeters (mm), and the width w of each is approximately 2 mm. The pair of spaced-apart speaker slots 202a and 202b, in certain embodiments, are separated by a distance d of 2 mm. The coupling between spaced-apart speaker slots 202a and 202b excites the speaker slots to operate as dual slot antennas with a wider bandwidth at 2.4 GHz than that provided using more conventional technologies. Coupling between the signal feed mechanism 204 (coupling feed monopole) and the pair of spaced-apart speaker slots 202a and 202b with lengthwise extent 50 mm excites the speaker slots to operate as dual slot antennas at higher-order modes. The higher-order modes of the dual slot antennas in combination with that of the 5 GHZ monopole effectively increase the operable bandwidth of dual-slot antenna system 200 and enable the system to operate within the 5-7 GHz frequency range.

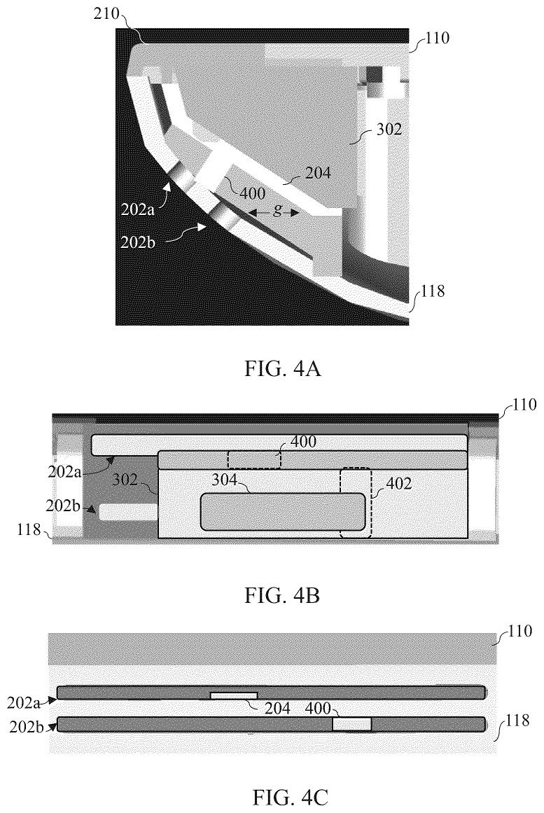

FIGS. 4A-4C illustrate an embodiment of dual-slot antenna system 200 configured to excite the pair of spaced-apart speaker slots 202a and 202b via a direct feed according to certain other embodiments of this disclosure. FIG. 4A is a cross-sectional view of an interior portion of D-case 118 of chassis 100 with signal feed mechanism 204 formed on speaker box 302. 4B is a cross-sectional forward view of the interior portion of D-case showing speaker box 302, within which is housed speaker transducer 304, and with spaced-apart speaker slots 202a and 202b behind the speaker box. FIG. 4C is a forward view of spaced-apart speaker slots 202a and 202b, looking into D-case 118. Within D-case 118, signal feed mechanism 204 is configured with pogo pin 400 extending from speaker box 302 and contacting with a portion of D-case 118 adjacent the pair of spaced-apart speaker slots 202a and 202b. Pogo pin 400 traverses the gap g between signal feed mechanism 204 and spaced-apart speaker slots 202a and 202b and is configured to provide a direct feed to the spaced-apart speaker slots.

In certain embodiments, signal feed mechanism 204 includes LDS traces for soldering of feed and ground coaxial cable to the speaker box. RF energy for exciting spaced-apart speaker slots 202a and 202b to operate as dual slot antennas may be generated by a transmitter or transceiver mounted on a motherboard within chassis 100. The RF energy is conveyed via signals carried by the coaxial cable and conveyed via pogo pin 400 to the speaker slots. Additionally, shorting pin 402 may extend from an edge of one of the pair of spaced-apart speaker slots 202a and 202b. The RF energy is capable of generating an alternating current that when directly fed to the pair of spaced-apart slots 202a and 202b via pogo pin 400 creates an electromagnetic wave that excites the spaced-apart slots to operate as dual slot antennas. Spaced-apart speaker slots 202a and 202b operate as dual slot antennas capable of resonating at 2.4 GHz when excited by the direct feed via pogo pin 400. With spaced-apart speaker slots 202a and 202b separated by a 2 mm gap and with shorting pin 402 approximately 13 mm from an edge of one of the speaker slots providing a short, the distribution of current (generated when the spaced-apart speaker slots are excited by the direct feed) is altered so that the speaker slots operate as dual slot antennas at frequencies within the 5-7 GHz range. Optionally, a parasitic arm to ground may be added, but primarily it is shorting pin 402 that contributes most to generating the higher-order modes that cover the 5-7 GHz bandwidth.

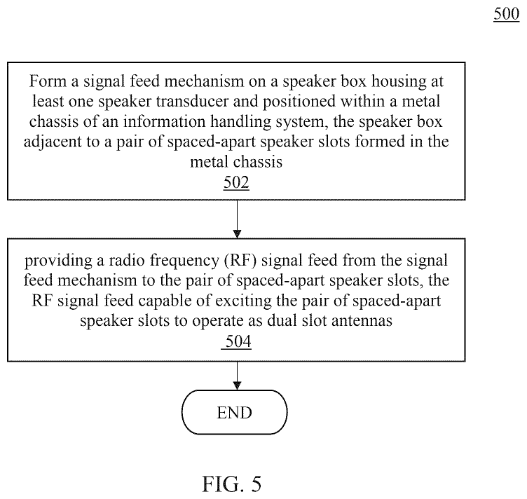

FIG. 5 is a flow diagram of method 500 for exciting a pair of spaced-apart speaker slots formed in an information handling system metal chassis to operate as dual slot antennas. It will be readily appreciated that not every method step set forth in this flow diagram is always necessary, and that certain steps of the method may be combined, performed simultaneously, in a different order, or perhaps omitted, without varying from the scope of the disclosure. Method 500 may be implemented with the various embodiments of dual-slot antenna system 200 described with reference to FIGS. 1-4.

At step 502, a signal feed mechanism is formed on a speaker box positioned within the metal chassis adjacent to the pair of spaced-apart speaker slots. Note that the spaced-apart speaker slots are separated by a gap between the signal feed mechanism and the speaker slots. In certain embodiments, the signal feed mechanism may be formed from conductive traces imprinted on the speaker box.

At step 504, an RF signal feed from the signal feed mechanism to the pair of spaced-apart speaker slots is provided. The RF signal feed is capable of exciting the pair of spaced-apart speaker slots to operate as dual slot antennas. In certain embodiments, the RF signal feed is a direct feed created by a pogo pin extending from the speaker box and contacting a portion of the metal chassis adjacent to the pair of spaced-apart speaker slots. When excited by a transmitter or transceiver, the signal feed mechanism is capable of generating an alternating current that is directly fed via the pogo pin to the pair of spaced-apart slots to generate an electromagnetic wave that excites the spaced-apart slots to operate as dual slot antennas. Additionally, a shorting pin may extend from an edge of one of the pair of spaced-apart speaker slots to a ground plane within the metal chassis.

In other embodiments, the RF signal feed is a coupling feed created by a coupling feed monopole formed on the speaker box. The metal chassis may be constructed with a base and a lid pivotally connected with the base. The speaker slots may be formed in the bottom portion of the base. The base may include a full metal D-case and a metal C-cover in which an antenna window is formed substantially above the speaker slots. The antenna window may be formed with a material that is RF transparent.

In some embodiments, the pair of spaced-apart speaker slots are separated by a distance of approximately 2 mm. The lengthwise extent of the pair of spaced-apart speaker slots may be approximately 50 mm. When excited by an RF signal feed, the spaced-apart speaker slots operate as dual slot antennas capable of resonating at 2.4 GHz. With the spaced-apart speaker slots separated by a 2 mm gap and a shorting pin approximately 13 mm from an edge of one of the speaker slots providing a short, the distribution of current (generated when the spaced-apart speaker slots are excited) is altered so that the speaker slots operate as dual slot antennas at frequencies within the 5-7 GHz frequency range.

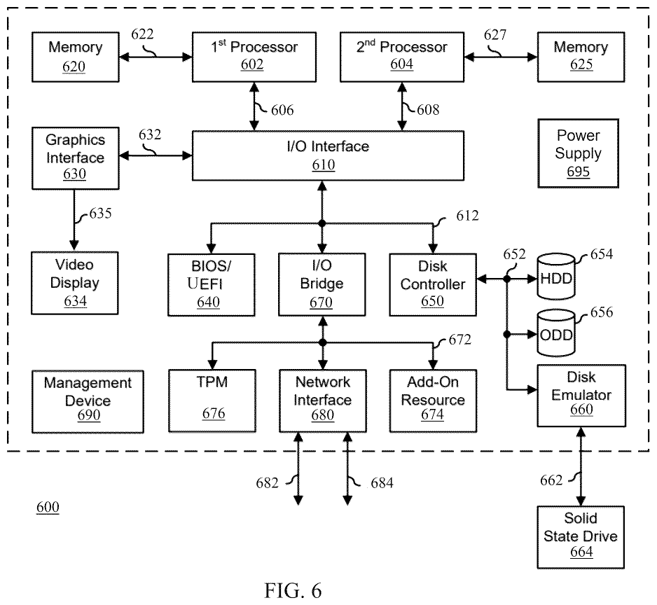

FIG. 6 shows a generalized embodiment of an information handling system 600 according to an embodiment of the present disclosure. Information handling system 600 may be substantially similar to an information handling system that may be housed within a metal chassis that includes a dual-slot antenna system such as that illustrated in FIGS. 1-4. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 600 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 600 can include processing resources for executing machine-executable code, such as a central processing unit (CPU), a programmable logic array (PLA), an embedded device such as a System-on-a-Chip (SoC), or other control logic hardware. Information handling system 600 can also include one or more computer-readable mediums for storing machine-executable code, such as software or data. Additional components of information handling system 700 can include one or more storage devices that can store machine-executable code, one or more communications ports for communicating with external devices, and various input and output (I/O) devices, such as a keyboard, a mouse, and a video display. Information handling system 600 can also include one or more buses operable to transmit information between the various hardware components.

Information handling system 600 can include devices or modules that embody one or more of the devices or modules described below and operates to perform one or more of the methods described below. Information handling system 600 includes a processors 602 and 604, an input/output (I/O) interface 610, memories 620 and 625, a graphics interface 630, a basic input and output system/universal extensible firmware interface (BIOS/UEFI) module 640, a disk controller 650, a hard disk drive (HDD) 654, an optical disk drive (ODD) 656, a disk emulator 660 connected to an external solid state drive (SSD) 664, an I/O bridge 670, one or more add-on resources 674, a trusted platform module (TPM) 676, a network interface 680, a management device 690, and a power supply 695. Processors 602 and 604, I/O interface 610, memory 620, graphics interface 630, BIOS/UEFI module 640, disk controller 650, HDD 654, ODD 656, disk emulator 660, SSD 664, I/O bridge 670, add-on resources 674, TPM 676, and network interface 680 operate together to provide a host environment of information handling system 600 that operates to provide the data processing functionality of the information handling system. The host environment operates to execute machine-executable code, including platform BIOS/UEFI code, device firmware, operating system code, applications, programs, and the like, to perform the data processing tasks associated with information handling system 600.

In the host environment, processor 602 is connected to I/O interface 610 via processor interface 606, and processor 604 is connected to the I/O interface via processor interface 608. Memory 620 is connected to processor 602 via a memory interface 622. Memory 625 is connected to processor 604 via a memory interface 627. Graphics interface 630 is connected to I/O interface 610 via a graphics interface 632 and provides a video display output 636 to a video display 634. In a particular embodiment, information handling system 600 includes separate memories that are dedicated to each of processors 602 and 604 via separate memory interfaces. An example of memories 620 and 630 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 640, disk controller 650, and I/O bridge 670 are connected to I/O interface 610 via an I/O channel 612. An example of I/O channel 612 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 610 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 640 includes BIOS/UEFI code operable to detect resources within information handling system 600, to provide drivers for the resources, initialize the resources, and access the resources. BIOS/UEFI module 640 includes code that operates to detect resources within information handling system 600, to provide drivers for the resources, to initialize the resources, and to access the resources.

Disk controller 650 includes a disk interface 652 that connects the disk controller to HDD 654, to ODD 656, and to disk emulator 660. An example of disk interface 652 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 660 permits SSD 664 to be connected to information handling system 600 via an external interface 662. An example of external interface 662 includes a USB interface, an IEEE 4394 (Firewire) interface, a proprietary interface, or a combination thereof. Alternatively, solid-state drive 664 can be disposed within information handling system 600.

I/O bridge 670 includes a peripheral interface 672 that connects the I/O bridge to add-on resource 674, to TPM 676, and to network interface 680. Peripheral interface 672 can be the same type of interface as I/O channel 612 or can be a different type of interface. As such, I/O bridge 670 extends the capacity of I/O channel 612 when peripheral interface 672 and the I/O channel are of the same type, and the I/O bridge translates information from a format suitable to the I/O channel to a format suitable to the peripheral channel 672 when they are of a different type. Add-on resource 674 can include a data storage system, an additional graphics interface, a network interface card (NIC), a sound/video processing card, another add-on resource, or a combination thereof. Add-on resource 674 can be on a main circuit board, on separate circuit board or add-in card disposed within information handling system 600, a device that is external to the information handling system, or a combination thereof.

Network interface 680 represents a NIC disposed within information handling system 600, on a main circuit board of the information handling system, integrated onto another component such as I/O interface 610, in another suitable location, or a combination thereof. Network interface device 680 includes network channels 682 and 684 that provide interfaces to devices that are external to information handling system 600. In a particular embodiment, network channels 682 and 684 are of a different type than peripheral channel 672 and network interface 680 translates information from a format suitable to the peripheral channel to a format suitable to external devices. An example of network channels 682 and 684 includes InfiniBand channels, Fibre Channel channels, Gigabit Ethernet channels, proprietary channel architectures, or a combination thereof. Network channels 682 and 684 can be connected to external network resources (not illustrated). The network resource can include another information handling system, a data storage system, another network, a grid management system, another suitable resource, or a combination thereof.

Management device 690 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 600. In particular, management device 690 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 600, such as system cooling fans and power supplies. Management device 690 can include a network connection to an external management system, and the management device can communicate with the management system to report status information for information handling system 600, to receive BIOS/UEFI or system firmware updates, or to perform other task for managing and controlling the operation of information handling system 600.

Management device 690 can operate off a separate power plane from the components of the host environment so that the management device receives power to manage information handling system 600 when the information handling system is otherwise shut down. An example of management device 690 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 690 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

That which is claimed is:

1. A dual-slot antenna system within a metal chassis of an information handling system, the dual-slot antenna system comprising:
a pair of spaced-apart speaker slots formed in the metal chassis;
a speaker box positioned within the metal chassis adjacent to the pair of spaced-apart speaker slots, the speaker box houses at least one speaker transducer; and
a signal feed mechanism formed on the speaker box,
wherein the signal feed mechanism is configured to feed radio frequency (RF) energy to the pair of spaced-apart speaker slots, and wherein the RF energy fed by the signal feed mechanism is capable of exciting the pair of spaced-apart speaker slots to operate as dual slot antennas.

2. The dual-slot antenna system of claim 1, wherein the signal feed mechanism comprises a pogo pin extending from the speaker box and contacting with a portion of the metal chassis adjacent to the pair of spaced-apart antennas.

3. The dual-slot antenna system of claim 2, further comprising:
a shorting pin extending from an edge of one of the pair of spaced-apart speaker slots to a ground plane within the metal chassis.

4. The dual-slot antenna system of claim 1, wherein the signal feed mechanism comprises a coupling feed monopole formed on the speaker box.

5. The dual-slot antenna system of claim 1, wherein the signal feed mechanism is imprinted on the speaker box by laser direct structuring.

6. The dual-slot antenna system of claim 1, wherein the metal chassis comprises a base and a lid pivotally connected with the base, and wherein the pair of spaced-apart speaker slots are formed in a bottom portion of the base.

7. The dual-slot antenna system of claim 6, wherein the base comprises a full metal D-case and a C-cover in which an antenna window is formed substantially above the pair of spaced-apart speaker slots, the antenna window formed with a material that is RF transparent.

8. The dual-slot antenna system of claim 1, wherein a distance separating the pair of spaced-apart speaker slots is approximately 2 millimeters (mm).

9. The dual-slot antenna system of claim 1, wherein a lengthwise extent of each of the pair of spaced-apart speaker slots is approximately 50 mm.

10. A method of enabling a pair of spaced-apart speaker slots formed in a metal chassis of an information handling system to operate as slot antennas, the method comprising:
forming a signal feed mechanism on a speaker box positioned within the metal chassis adjacent to the pair of spaced-apart speaker slots, the speaker box houses at least one speaker transducer; and
providing a radio frequency (RF) signal feed from the signal feed mechanism to the pair of spaced-apart speaker slots,
wherein RF signal feed is capable of exciting the pair of spaced-apart speaker slots to operate as dual slot antennas.

11. The method of claim 10, wherein the RF signal feed is a direct feed created by a pogo pin extending from the speaker box and contacting with a portion of the metal chassis adjacent to the pair of spaced-apart speaker slots.

12. The method of claim 11, further comprising extending a shorting pin from an edge of one of the pair of spaced-apart speaker slots to a ground plane within the metal chassis.

13. The method of claim 10, wherein the RF signal feed is a coupling feed created by a coupling feed monopole formed on the speaker box.

14. The method of claim 10, wherein the metal chassis comprises a base and a lid pivotally connected with the base, and wherein the pair of spaced-apart speaker slots are formed in a bottom portion of the base.

15. The method of claim 14, wherein the base comprises a full metal D-case and a metal C-cover in which an antenna window is formed substantially above the pair of spaced-apart speaker slots, the antenna window formed with a material that is RF transparent.

16. The method of claim 10, wherein a distance separating the pair of spaced-apart speaker slots is approximately 2 millimeters (mm).

17. The method of claim 10, wherein a lengthwise extent of each of the pair of spaced-apart speaker slots is approximately 50 mm.

18. An information handling system, comprising:
a metal chassis having a base and a lid pivotally connected with the base;
one or more processing units housed within the metal chassis;
a pair of spaced-apart speaker slots formed in the metal chassis;
a speaker box positioned within the metal chassis adjacent to the pair of spaced-apart speaker slots, the speaker box houses at least one speaker transducer; and
a signal feed mechanism formed on the speaker box,
wherein the signal feed mechanism is configured to feed radio frequency (RF) energy to the pair of spaced-apart speaker slots, and wherein the RF energy fed by the signal feed mechanism is capable of exciting the pair of spaced-apart speaker slots to operate as dual slot antennas.

19. The information handling system of claim 18, wherein the signal feed mechanism comprises:
a pogo pin extending from the speaker box and contacting with a portion of the metal chassis adjacent to the pair of spaced-apart antennas; and
a shorting pin extending from an edge of one of the pair of spaced-apart speaker slots to a ground plane within the metal chassis.

20. The information handling system of claim 18, wherein the signal feed mechanism comprises a coupling feed monopole formed on the speaker box.
